(19) United States
(12) Patent Application Publication
(10) Pub. No.: US 2015/0183124 A1
(43) Pub. Date: Jul. 2, 2015

(54) Cutter tooth for a saw chain

(71) Applicant: Andreas Stihl AG & Co. KG, Waiblingen (DE)

(72) Inventors: Berthold Schell, Backnang (DE); Oliver Gerstenberger, Ditzingen (DE)

(21) Appl. No.: 14/561,545

(22) Filed: Dec. 5, 2014

(30) Foreign Application Priority Data
Dec. 14, 2013 (DE) 10 2013 021 170.0

(51) Int. Cl. B27B 33/14

(52) U.S. Cl. CPC B27B 33/142; B27B 33/141

(57) ABSTRACT

A cutter tooth has a base member with rivet openings spaced at a rivet spacing. A cutting element is attached by brazing to the base member at the upper edge of the base member. A depth limiter is provided on the base member in front of the cutting element. A chip recess is formed between depth limiter and cutting element. The depth limiter has an upright edge delimiting the chip recess. A forward contour of the lateral section of the cutting element and an inner contour of the chip recess define a corner point within the chip recess. The corner point is positioned at a first spacing relative to the upright edge of the depth limiter. The rivet spacing is divided by a perpendicular center plane positioned at a second spacing relative to the upright edge of the depth limiter. The first spacing is smaller than the second spacing.

### BACKGROUND OF THE INVENTION

The invention relates to a cutter tooth for a saw chain comprising a base member and a hardmetal cutting element attached to the base member, wherein the base member has an upper edge and a lower base area with rivet openings sequentially arranged in the running direction of the cutter tooth, including a forward rivet opening and rear rivet opening. In front of the cutting element in the running direction, a depth limiter is provided on the base member. The cutting element has a roof section with a roof cutting edge arranged in a depression in the upper edge of the base member as well as a lateral section with a lateral cutting edge arranged on the lateral surface of the base member. A chip recess for discharging chips is provided between the depression and the depth limiter. The cutting element projects into the chip recess in the running direction. In a side view of the base member, the forward contour of the lateral section and the inner contour of the chip recess form a corner point located within the chip recess. The cutting element and the base member are materially fused by a thermal connecting method. The center axes of the rivet openings have a rivet spacing relative to each other that is divided at the center by a center plane that is perpendicular to the rivet spacing.

U.S. Pat. No. 8,028,610 B2 discloses a cutter tooth of the aforementioned kind comprised of base member and hardmetal cutting element attached to the base member. In the base area of the base member rivet openings arranged sequentially in the running direction of the cutter tooth are formed. In the running direction in front of the cutting element, a depth limiter is provided on the base member. Between the depth limiter and the cutting element a chip recess is formed. The cutting element is secured in a depression in the upper edge of the base member in that a lateral section of the cutting element is fastened by brazing on the lateral surface of the base member. Good cutting results are achieved with this known cutter tooth.

However, the hardmetal cutting element is of a small size relative to the base member so that the brazing surfaces that connect the cutting element to the base member are small.

### SUMMARY OF THE INVENTION

It is an object of the invention to further develop a cutter tooth of the aforementioned kind in such a way that a resistant connection provided with a large surface area between the cutting element of hardmetal (tungsten carbide, cemented carbide) and the base member of the cutter tooth is generated in order to increase the cutting performance and the service life of the cutter tooth.

In accordance with the invention, this is achieved in that the corner point is positioned at a first spacing relative to an upright edge of the depth limiter that delimits the chip recess, wherein the first spacing is smaller than a second spacing of the center plane relative to the upright edge of the depth limiter and wherein the upright edge of the depth limiter in the running direction is positioned in front of the center axis of the forward rivet opening that is leading in the running direction.

In a side view of the chip recess, the inner contour of the chip recess and the leading contour of the lateral section of the cutting element that is projecting into the chip recess define a corner point which is located within the chip recess. According to the invention, the corner point is positioned in the running direction of the cutter tooth so far forwardly that the corner point is positioned at a first spacing relative to an upright edge of the depth limiter that delimits the chip recess and this first spacing is smaller than a second spacing of a center plane relative to the upright edge of the depth limiter. This center plane divides the rivet spacing between the rivet openings wherein the distance line between the two center axes of the rivet openings is perpendicular to the center plane. The design is selected such that, in a side view, the upright edge of the depth limiter in the running direction is positioned in front of the center axis of the forward rivet opening that is leading in the running direction. Viewed in a plan view of the cutter tooth, the chip recess extends thus to a point that is in front of the center axis of the forward rivet opening in the running direction.

According to the invention, the corner point is positioned, in the running direction, in the forward half of the rivet spacing, i.e., in the running direction in front of the center plane that divides the rivet spacing and that is positioned perpendicularly to the rivet spacing.

With this geometric configuration, a cutter tooth is provided which resists even great stresses and loads, exhibits an excellent cutting performance, and ensures a long service life.

Expediently, the first spacing of the corner point from the upright edge of the depth limiter has a size of 0.5 times up to 0.8 times the size of the second spacing of the center plane relative to the upright edge of the depth limiter.

In a special configuration, the first spacing of the corner point to the upright edge is designed such that the size of the first spacing is 0.6 times to 0.7 times, in particular 0.65 times, the size of the second spacing of the upright edge relative to the center plane.

The depression that is provided for receiving the preferably L-shaped cutting element extends in the running direction across a length that has a size of approximately 70% to 90% of a size of the section length of the upper edge of the base member that extends between the chip recess and the rear terminal edge of the base member in the running direction.

Expediently, the depression has an end that is remote from the depth limiter and that forms a stop for the cutting element. The roof section of the cutting element is contacting the stop so that the cutting element is supported with its roof section at the stop in a direction opposite to the running direction of the cutter tooth.

The position of the cutting element on the base member and the length of the cutting element itself are to be selected such that the rearward end of the cutting element in the running direction ends behind the rear rivet opening. The length of the cutting element measured in the running direction corresponds to preferably 70% to 100% of the size of the rivet spacing of the center axes of the rivet openings from each other. In particular, the length is selected to be 90% of the size of the rivet spacing.

The geometry of the cutting element is designed such that a ratio of the maximum height of the cutting element measured perpendicularly to the running direction relative to a maximum length of the cutting element measured in the running direction is in a range of 0.4 to 0.5 and is in particular 0.46.

The cutting element itself has a lateral section that comprises a lower longitudinal edge which extends in the running direction and is facing the rivet openings. This longitudinal edge extends across the length of the cutting element at an angle, preferably at an angle of 0.5° to 2°, relative to a reference plane which is determined by the center axes of the rivet openings.

The position of the corner point relative to the base member of the cutter tooth is selected such that the distance between the center axis of the rear rivet opening which is trailing in the running direction and the corner point in the chip recess is 85% to 110% of the size of the rivet spacing of the center axes of the rivet openings relative to each other measured in the running direction.

In particular, a distance of the center axis to the corner point is selected to be approximately 95% of the size of the rivet spacing. This distance line between the center axis of the rear rivet opening and the corner point in the chip recess is positioned at an angle of 35° to 40° relative to a reference plane that is defined by the center axes of the rivet openings. In particular, the angle of the distance line relative to the reference plane is 37°.

The depth limiter of the cutter tooth is formed monolithic with the base member of the cutter tooth. In particular, it is designed as a residual web which is bent out of the plane of the base member. The residual web is a forwardly positioned section in the running direction which remains at the forward end of the base member after forming the chip recess.

The base member itself is embodied as a flat plate wherein the residual web is initially positioned in the plane of this plate. For forming the depth limiter, the residual web is angled away from the plane of the plate.

### BRIEF DESCRIPTION OF THE DRAWING

FIG. 1 is a perspective illustration of a cutter tooth according to the invention with a cutting element made of hardmetal.

FIG. 2 is a side view of the cutter tooth according to FIG. 1.

FIG. 3 is a further side view of the cutter tooth according to FIG. 1.

FIG. 4 is a plan view of the cutter tooth according to FIG. 1.

FIG. 5 is a bottom view of the cutter tooth of FIG. 1.

FIG. 6 is a front view of the cutter tooth according to FIG. 1.

FIG. 7 is a rear view of the cutter tooth according to FIG. 1.

### DESCRIPTION OF THE PREFERRED EMBODIMENTS

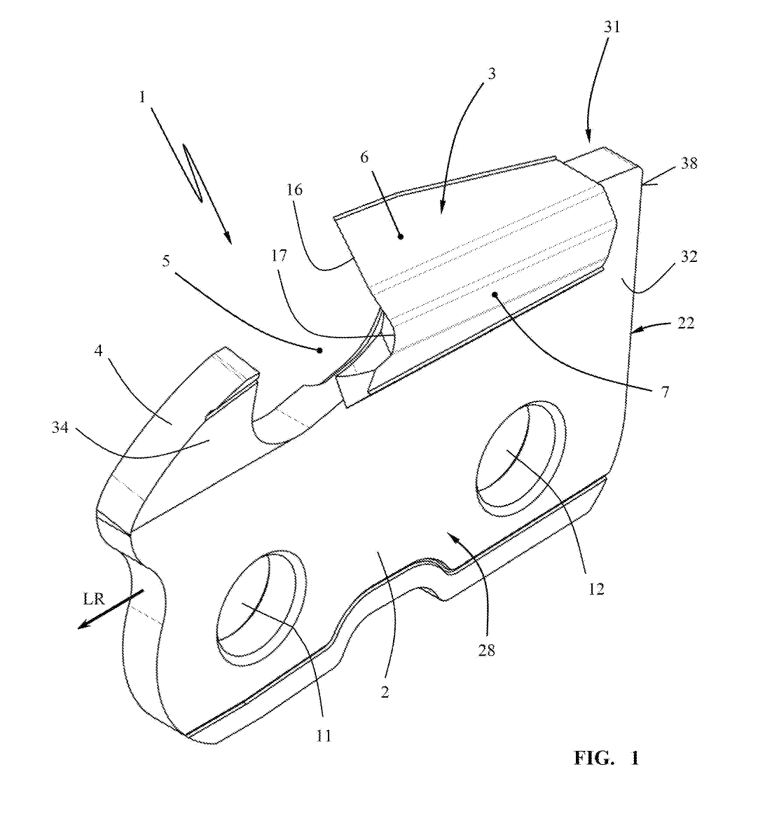

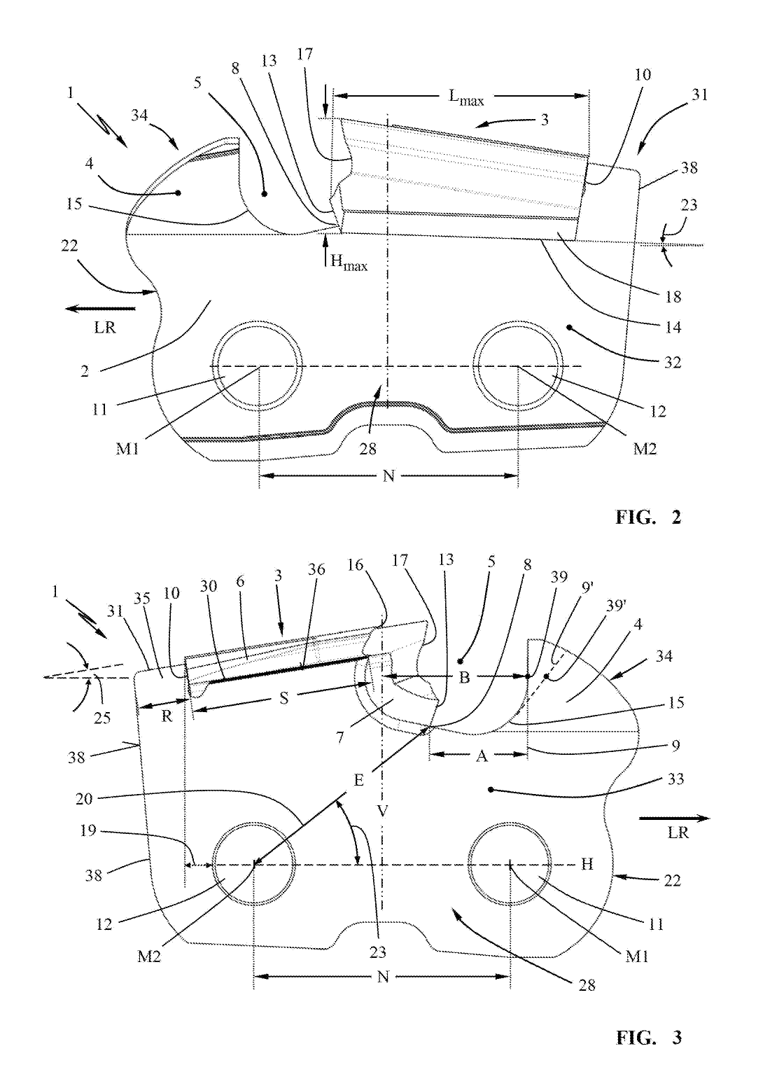

The cutter tooth 1 illustrated in the Figures comprises a base member 2 which is comprised substantially of a flat plate 22. The base member 2 comprises, as can be seen in particular in the side views of FIGS. 2 and 3, an upper edge 31 and a lower base area 28. In the lower base area 28, rivet openings 11 and 12 are formed in the plate 22 of the base member 2 (FIGS. 1 to 3) and are sequentially arranged in the running direction LR of the cutter tooth 1. The rivet opening 11 is a forward rivet opening leading in the running direction LR while the rivet opening 12 is a rear rivet opening trailing in the running direction LR.

As shown in FIGS. 2 and 3, each rivet opening has a center axis M1 and M2 positioned in the running direction LR at a rivet spacing N relative to each other.

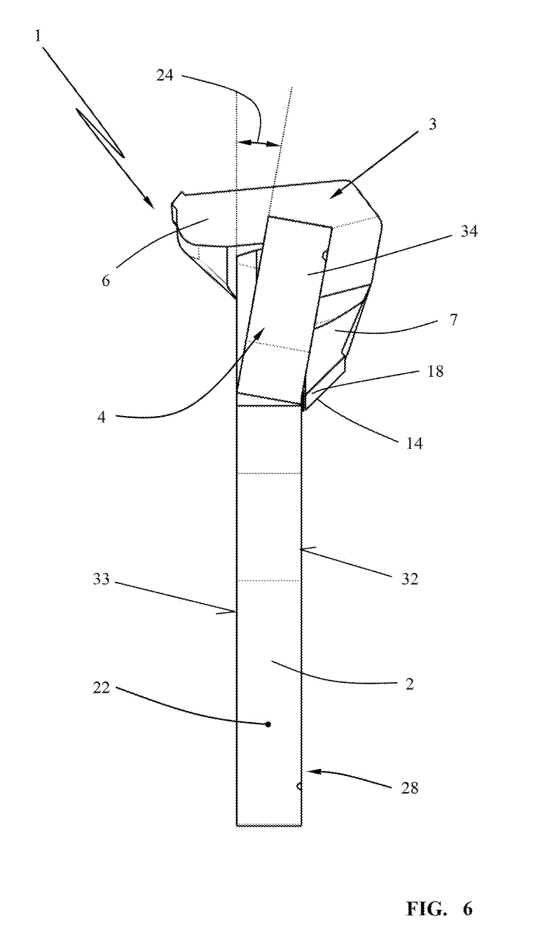

At the upper edge 31 of the base member 2, a chip recess 5 is formed that extends between a depression 30 (FIG. 3) within the upper edge 31 and a residual web 34 that is forwardly positioned in the running direction LR. The residual web 34 is angled out of the plane of the plate 22, as can be seen clearly in FIGS. 1 and 6. The angled residual web 34 forms a depth limiter 4 of the cutter tooth 1.

The depression 30 (FIG. 3) opens into the chip recess 5 at its forwardly positioned end in the running direction LR while at the rearward end a residual section 35 of the upper edge 31 forms a stop 10 for a cutting element 3.

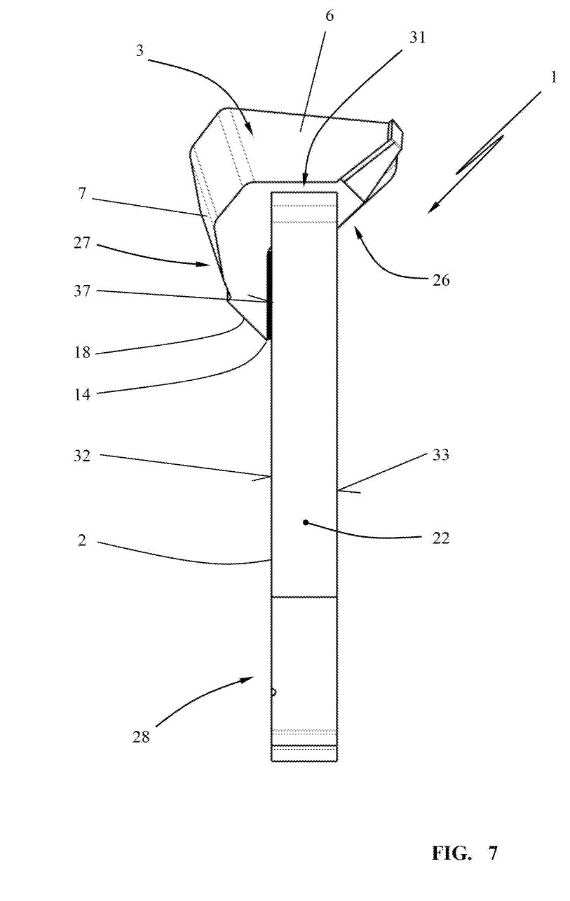

The cutting element 3, as shown in FIG. 7, has an L-shaped basic shape viewed in the running direction LR. The lateral leg 27 of the base body of the cutting element 3 resting on the lateral surface 32 of the base member 2 forms a lateral section 7 of the cutting element 3. A roof leg 26 positioned at an angle relative to the lateral surface 32 forms a roof section 6 of the cutting element 3.

The roof surface of the roof section 6 is positioned at an angle 25 of approximately 9° relative to the reference plane H wherein the angle 25 opens forwardly in the running direction LR.

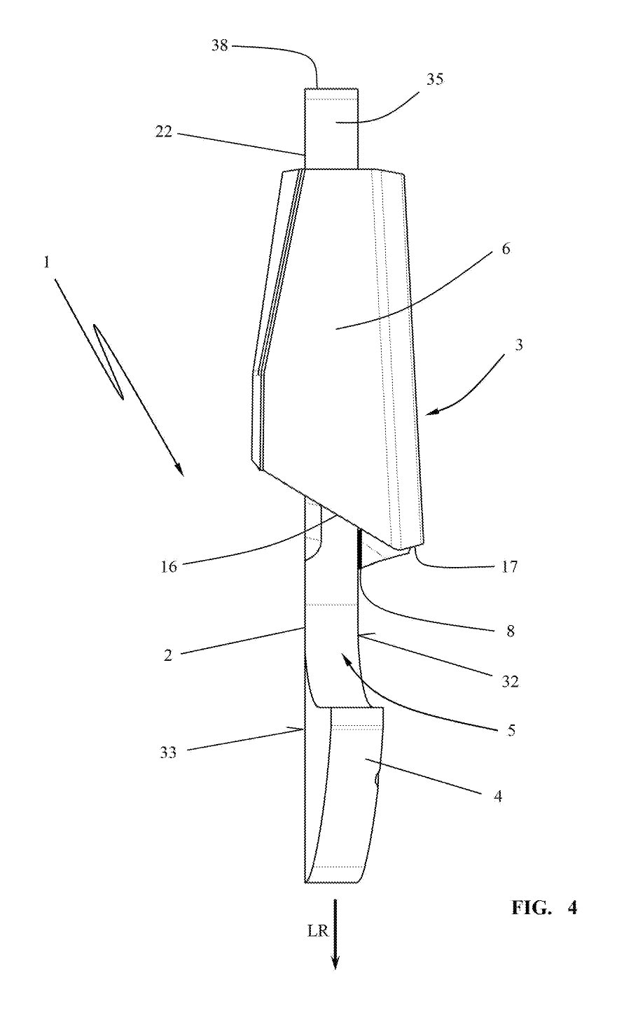

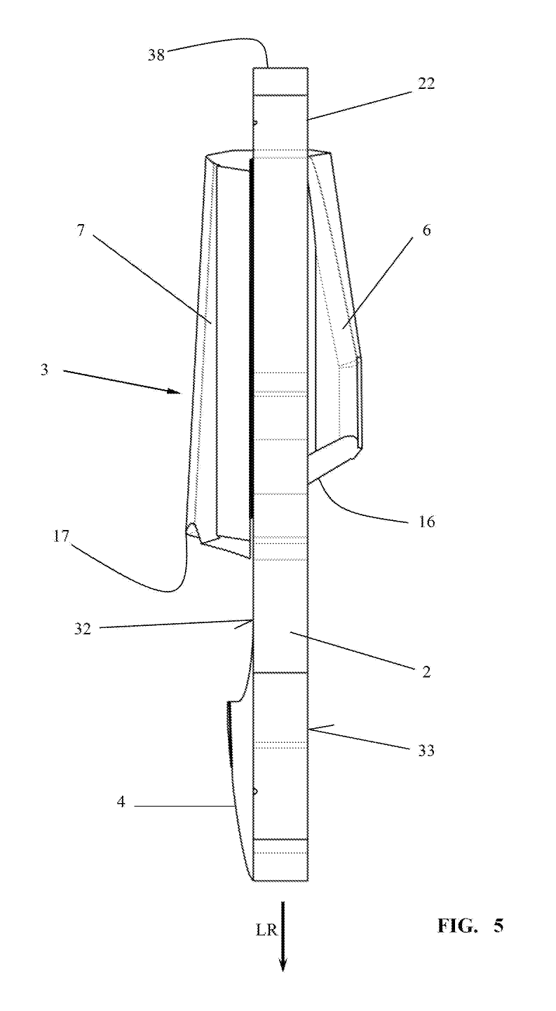

As can be seen in particular in FIGS. 1, 3, and 4, on the edge of the roof section 6, which is forwardly positioned in the running direction LR, a roof cutting edge 16 is formed. On the forwardly positioned edge of the lateral section 7 in the running direction LR, a lateral cutting edge 17 is formed. The lateral cutting edge 17 is designed in the form of a hollow, i.e., is concave.

The cutting element 3 is comprised of hardmetal (tungsten carbide, cemented carbide) and is connected by a thermal connecting method, i.e., heat is applied, for example, by brazing, with material fusion to the base member 2 of the cutter tooth 1.

As is shown in particular in FIG. 3 and FIGS. 5 through 7, the surface 37 of the lateral section 7 resting on the lateral surface 32 of the base member 2 is secured flat on the lateral surface 32 of the base member 2. Preferably, the entire surface area of the surface 37 of the lateral section 7 is attached by material fusion to the surface 32 of the base member 2, for example, by brazing.

As is shown in FIG. 3, the roof section 6 is positioned in the depression 30 wherein the bottom 36 of the depression 30 is connected by material fusion to the contact surface of the roof section 6. Preferably, the roof section 6 is connected by material fusion across the entire bottom surface 36 with the base member 2, preferably by brazing.

As shown in FIG. 3, the length S of the depression 30 is shorter than the maximum length Lₘₐₓ (FIG. 2) of the cutting element 3. The cutting element 3 projects thus into the chip recess 5. The roof section 6 as well as the lateral section 7 project into the chip recess 5.

In the running direction LR, the edge contour 15 of the chip recess 5 and the leading contour 13 of the lateral section 7 of the cutting element 3 form, in a side view of the base member 2 (see FIG. 3), a corner point 8 which is located within the chip recess 5.

For determining the position of the corner point 8 within the chip recess 5, a center plane V is defined which divides the rivet spacing N at the center. The distance line of the rivet spacing N is positioned perpendicularly to the center plane V.

The depth limiter 4 has an upright edge 9 (FIG. 3) that delimits the chip recess 5. In the illustrated embodiment, this upright edge 9 in a side view is substantially vertical, i.e., the upright edge 9 is perpendicular to the reference plane H that is determined by the first and second center axes M1 and M2 of the rivet openings 11, 12. The upright edge 9′ can also be slanted in the running direction LR, as indicated by dashed lines.

The corner point 8 which is defined by the contour 13 of the lateral section 7 and the contour 15 of the chip recess 5 is positioned at a first spacing A relative to the upright edge 9. The center plane V is positioned at a second spacing B relative to the upright edge 9. The geometry is selected such that the first spacing A is smaller than the second spacing B. In the running direction LR, the upright edge 9 is positioned in front of the first center axis M1 of the forward rivet opening 11. This can be seen in the side view of FIG. 3.

As also shown in FIG. 3, the first and second spacings A and B are measured in the running direction LR of the cutter tooth 1. The first spacing A or the second spacing B is measured in the running direction LR relative to the same distance point 39 toward the center plane V. When the upright edge 9, as indicated in dashed lines with reference character 9′, is e.g. slanted in the running direction LR, the same distance conditions result relative to the distance point 39′ of the slanted edge 9′ as for the upright edge 9 perpendicularly arranged relative to the reference plane H.

The constructive configuration and design of the cutter tooth 1 provides for a high operational safety for an extended service life wherein the cutting element 3 is connected by means of a maximum surface area by material fusion to the flat plate 22 of the base member 2, for example, by brazing solder, in particular by a silver brazing alloy.

Opposite to the running direction LR, the cutting element 3 is supported on a stop 10 on which the roof section 6 of the cutting element 3 is resting in a direction opposite to the running direction LR. The stop 10 forms the rearward end of the depression 30 in the running direction LR. The end of the base member 2 which is provided with the stop 10 is facing away from the depth limiter 4. The surface of the stop 10, in the running direction LR, is positioned behind the trailing rivet opening 12. Expediently, in a side view of the base member 2, the stop 10 has a spacing 19 relative to the rivet opening 12 measured in the running direction LR.

The depression 30 extends rearwardly, opposite to the running direction LR of the cutter tooth 1, to a point past the rear rivet opening 12 so that only a small residual section 35 of the upper edge 31 with a residual length R remains.

Expediently, the configuration of the base member 2 and of the cutting element 3 are matched to each other such that the first spacing A of the corner point 8 from the distance point 39 or 39′ has a size of 0.5 times to 0.8 times the size of the second spacing B of the distance point 39 or 39′ from the center plane V. In an optimized embodiment of the cutter tooth 1, the first spacing A is selected such that it has a size of 0.6 times to 0.7 times the size of the second spacing. An expedient embodiment is achieved when the first spacing A is 0.65 times the size of the second spacing B.

The depression 30 extending in the running direction LR within the upper edge 31 has a length S that is approximately 70% to 90% of the size of the section length of the upper edge 31 extending between the chip recess 5 and the rear terminal edge 38 of the base member 2.

The constructive configuration is designed such that the maximum length Lₘₐₓ of the cutting element 3 measured in the running direction LR corresponds to approximately 70% to 90% of the size of the rivet spacing N between the first and second center axes M1 and M2 of the rivet openings 11 and 12. An advantageous configuration is achieved when the measured length Lₘₐₓ measured in the running direction LR is approximately 90% of the size of the rivet spacing N.

The geometry of the cutting element 3 is moreover designed such that the ratio of a maximum height Hₘₐₓ of the cutting element 3, measured perpendicularly to the running direction LR, to a maximum length Lₘₐₓ of the cutting element 3, measured in the running direction LR, is in the range of 0.4 to 0.5, as illustrated in FIG. 2. An optimal configuration is achieved when a ratio of 0.46 is adjusted.

FIG. 2 shows furthermore that the lateral section 7 has a lower longitudinal edge 14 which is facing the rivet openings 11, 12 and is extending in the running direction LR across the length Lₘₐₓ of the cutting element 3. Expediently, the lower longitudinal edge 14 is positioned at an angle 23 of 0.5 degrees to 2° to the reference plane H through the first and second center axes M1 and M2 of the rivet openings 11 and 12. The lower longitudinal edge 14 of the lateral section 7 delimits the bevel 18 formed at the lower end of the lateral section 7 and extending in the running direction LR.

The distance E between the second center axis M2 of the rear rivet opening 12 trailing in the running direction LR and the corner point 8 in the chip recess 5 is selected such that the distance E has a size of approximately 85% to 110% of the size of the rivet spacing N of the first and second center axes M1 and M2 of the rivet openings 11 and 12 that is measured in the running direction LR. Expediently, the distance E is selected to have a size of 95% of the size of rivet spacing N.

The distance line 20 between the second center axis M2 of the rear rivet opening 12 and the corner point 8 in the chip recess 5 is positioned relative to the reference plane H at an angle 23 of between 35° and 40°. In particular, the position of the corner point 8 is selected such that the angle 23 has a size of approximately 37°.

The depth limiter 4 which is bent out of the plane of the plate 22 of the base member 2 is angled at an angle 24 of approximately 10° to 15°, in particular 12°, relative to the plane of the plate 22. In the illustrated embodiment, the depth limiter 4 is monolithic with the base member 2.

The specification incorporates by reference the entire disclosure of German priority document 10 2013 021 170.0 having a filing date of Dec. 14, 2013.

While specific embodiments of the invention have been shown and described in detail to illustrate the inventive principles, it will be understood that the invention may be embodied otherwise without departing from such principles.

What is claimed is:

1. A cutter tooth for a saw chain, the cutter tooth comprising:
a base member;
a hardmetal cutting element attached to the base member;
the base member comprising an upper edge and a lower base area;
the base member comprising rivet openings formed in the lower base area, wherein the rivet openings are sequentially arranged in a running direction of the cutter tooth and form a forward rivet opening and a rear rivet opening;
the base member comprising a depth limiter arranged in front of the hardmetal cutting element in the running direction;
the hardmetal cutting element comprising a roof section with a roof cutting edge and further comprising a lateral section with a lateral cutting edge, wherein the lateral section is resting on a lateral surface of the base member and the roof section is arranged in a depression provided in the upper edge of the base member;
the base member comprising a chip recess arranged between the depression and the depth limiter to discharge chips produced by cutting;
the hardmetal cutting element projecting into the chip recess in the running direction;
in a side view of the base member, a forward contour of the lateral section of the hardmetal cutting element and an inner contour of the chip recess defining a corner point located within the chip recess;
the hardmetal cutting element fastened to the base member by material fusion by a thermal connecting method;
the forward rivet opening comprising a first center axis and the rear rivet opening comprising a second center axis, wherein the first and second center axes are positioned at a rivet spacing relative to each other;
the rivet spacing divided centrally by a center plane that is perpendicular to the rivet spacing;
the depth limiter comprising an upright edge that is in front of the first center axis of the forward rivet opening positioned in the running direction and that delimits the chip recess;
the corner point positioned at a first spacing relative to the upright edge of the depth limiter;
the center plane positioned at a second spacing relative to the upright edge of the depth limiter, wherein the first spacing is smaller than the second spacing.

2. The cutter tooth according to claim 1, wherein the first spacing has a size that is 0.5 times to 0.8 times a size of the second spacing.

3. The cutter tooth according to claim 2, wherein the size of the first spacing is 0.6 times to 0.7 times the size of the second spacing.

4. The cutter tooth according to claim 3, wherein the size of the first spacing is 0.65 times the size of the second spacing.

5. The cutter tooth according to claim 1, wherein the depression has a length measured in the running direction that has a size that is 70% to 90% of a size of a section length of the upper edge of the base member, the section length extending between the chip recess and a rear terminal edge of the base member in the running direction.

6. The cutter tooth according to claim 5, wherein the depression has an end positioned remote from the depth limiter and forming a stop, wherein the roof section of the hardmetal cutting element is resting at the stop and is supported at the stop in a direction opposite to the running direction.

7. The cutter tooth according to claim 5, wherein a rearward end of the hardmetal cutting element ends behind the rear rivet opening in the running direction.

8. The cutter tooth according to claim 1, wherein a maximum length of the hardmetal cutting element measured in the running direction has a size of 70% to 100% of a size of the rivet spacing.

9. The cutter tooth according to claim 8, wherein the size of the maximum length is 90% of the size of the rivet spacing.

10. The cutter tooth according to claim 8, wherein a ratio of a maximum height of the hardmetal cutting element, measured perpendicularly to the running direction, to the maximum length is in a range of 0.4 to 0.5.

11. The cutter tooth according to claim 10, wherein the ratio is 0.46.

12. The cutter tooth according to claim 1, wherein the lateral section of the hardmetal cutting element comprises a longitudinal edge, facing the rivet openings and extending in the running direction across a length of the hardmetal cutting element, wherein the longitudinal edge is positioned at an angle of 0.5° to 2° relative to a reference plane that is extending through the first and second center axes of the rivet openings.

13. The cutter tooth according to claim 1, wherein a size of a distance between the second center axis of the rear rivet opening and the corner point in the chip recess is 85% to 110% of a size of the rivet spacing.

14. The cutter tooth according to claim 13, wherein the size of the distance is 95% of the size of the rivet spacing.

15. The cutter tooth according to claim 13, wherein a distance line between the second center axis of the rear rivet opening and the corner point in the chip recess is positioned at an angle between 35° and 40° relative to a reference plane that is extending through the first and second center axes of the rivet openings.

16. The cutter tooth according to claim 15, wherein the angle is 37°.

17. The cutter tooth according to claim 1, wherein the depth limiter is monolithic with the base member and is a residual web bent out of a plane of the base member.

18. The cutter tooth according to claim 1, wherein the base member is a flat plate.

19. The cutter tooth according to claim 18, wherein the depth limiter is angled out of a plane of the flat plate.
